(19) United States
(12) Patent Application Publication
(10) Pub. No.: US 2021/0391677 A1
(43) Pub. Date: Dec. 16, 2021

(54) CONNECTOR AND THREE-WAY TRANSMISSION AND CONVERSION CIRCUIT MODULE

(71) Applicant: Siemens Aktiengesellschaft, Muenchen (DE)

(72) Inventors: Rong Liang MU, Nanjing (CN); Hai Jun WANG, Nanjing (CN); Bin YANG, Nanjing (CN)

(73) Assignee: Siemens Aktiengesellschaft, Muenchen (DE)

(21) Appl. No.: 17/285,529

(22) PCT Filed: Oct. 23, 2018
(86) PCT No.: PCT/CN2018/111469

§ 371 Date: Apr. 15, 2021

(51) Int. Cl. H01R 31/02; H01R 12/72; H01R 13/627; H01R 13/514; H01R 12/70

(52) U.S. Cl. CPC H01R 31/02; H01R 12/721; H01R 12/7076; H01R 13/514; H01R 13/6273

(57) ABSTRACT

A connector is disclosed. In an embodiment, the connector includes a first connection part and a second connection part. The first connection part and the second connection part form a groove suitable for accommodating a circuit board when the first connection part and the second connection part are assembled together, and elastic parts are disposed on opposite inner surfaces of the groove. Furthermore, a corresponding three-way transmission and conversion circuit module is disclosed, including the connector.

### PRIORITY STATEMENT

This application is the national phase under 35 U.S.C. § 371 of PCT International Application No. PCT/CN2018/111469 which has an International filing date of Oct. 23, 2018, which designated the United States of America, the entire contents of which are hereby incorporated herein by reference.

### FIELD

Embodiments of the present invention generally relate to the industrial field, and in particular, to an improved connector.

### BACKGROUND

Connector, as a signal transmission and conversion apparatus, plays an important role in an industrial control field. At present, a connector is usually fixed on a circuit board via welding, or connected through cables for use, so as to realize signal conversion and transmission between a front-end input and a rear-end output.

### SUMMARY

The inventors have discovered that current connection modes of the connector cause a product to have a redundant volume and a small volume density, and need a complicated process. In addition, the inventors have discovered that the connector welded on a circuit board is undetachable and causes poor compatibility. In view of this, the inventors have discovered that it is necessary to improve the conventional connector, so as to resolve the aforementioned problem.

In view of the aforementioned problem, at least one embodiment of the present invention aims at providing a connector that has a simple structure and can be assembled conveniently.

According to one embodiment of the present invention, a connector is provided. The connector includes a first connection part and a second connection part, where the first connection part and the second connection part form a groove suitable for accommodating a circuit board when the first connection part and the second connection part are assembled together, and elastic parts are disposed on opposite inner surfaces of the groove.

According to another embodiment of the present invention, a three-way transmission and conversion circuit module is provided. The three-way transmission and conversion circuit module includes a circuit board, having a signal conversion circuit thereon, where an upper surface and a lower surface of the circuit board both have a conductive sheet; and the aforementioned connector, where apart of the circuit board is inserted into the groove detachably to allow the elastic part to contact the conductive sheet.

### BRIEF DESCRIPTION OF THE DRAWINGS

The accompanying drawings provide further interpretation for the present invention and are collected as one part of this application, and the accompanying drawings show the embodiments of the present invention, and together with the specification, interpret the principle of the present invention. In the accompanying drawings:

FIG. 1 shows a connector according to the prior art;

FIG. 2 shows another connector according to the prior art;

FIG. 3 is a three-dimensional exploded view of a connector according to an embodiment of the present invention;

FIG. 4 is a three-dimensional exploded view of a connector according to an embodiment of the present invention; and

FIG. 5 shows an application of a connector according to an embodiment of the present invention.

### LIST OF REFERENCE NUMERALS

1: Connector
10: Depressed part
11: First connection part
112: First base
114: First pin row
12: Second connection part
122: Second base
124: Second pin row
13: Groove
14: Elastic part
15: Positioning column
16: Positioning hole
17: Locking part
18: Threaded hole
2: Circuit board
3: Cable

### DETAILED DESCRIPTION OF THE EXAMPLE EMBODIMENTS

According to one embodiment of the present invention, a connector is provided. The connector includes a first connection part and a second connection part, where the first connection part and the second connection part form a groove suitable for accommodating a circuit board when the first connection part and the second connection part are assembled together, and elastic parts are disposed on opposite inner surfaces of the groove.

According to an embodiment of the present invention, at least one of the first connection part and the second connection part includes at least one terminal that is suitable to be plugged into an external port, the at least one terminal is electrically connected to the elastic part, the elastic part includes at least one metal elastic sheet, and the at least one elastic sheet is electrically connected to the at least one terminal in a one-to-one correspondence.

According to an embodiment of the present invention, the terminal further includes a first terminal and a second terminal; the first connection part includes a first base and the first terminal disposed on an external side of the first base, and the first terminal includes a first pin row; the second connection part includes a second base and the second terminal disposed on an external side of the second base, and the second terminal includes a second pin row; and a depressed part is formed at the center of an inner end face of the first base and/or the second base relative to two ends, so as to form the groove when the first base and the second base are docked.

According to an embodiment of the present invention, the first base and the second base are both made of an insulating material through integrated injection molding.

According to an embodiment of the present invention, the elastic part includes at least one metal elastic sheet, the metal elastic sheets are uniformly distributed at central positions of inner side surfaces of the first base and the second base, and the quantity and positions of the metal elastic sheets are respectively corresponding to the quantity and positions of pins of the first pin row and the second pin row.

According to an embodiment of the present invention, the connector further includes positioning columns disposed on the first connection part; and positioning holes formed in the second connection part, where the first connection part and the second connection part are fixedly connected through cooperation of the positioning columns and the positioning holes.

According to an embodiment of the present invention, the connector further includes locking parts, disposed on inner side surfaces of the groove oppositely and each having a hook structure extending along an inner edge of the groove.

According to an embodiment of the present invention, the connector further includes threaded holes, formed in the first connection part and the second connection part, where the threaded holes are suitable for accommodating threaded connection pieces, so that the first connection part and the second connection part are fixed through the threaded connection pieces.

According to an embodiment of the present invention, the connector is a D-Sub connector, the first connection part has one connector structure of a male head or a female head, and the second connection part has the other connector structure of the male head or the female head.

According to an embodiment of the present invention, the connector is any one of DB9, DB15, DB25, and DB37.

According to another embodiment of the present invention, a three-way transmission and conversion circuit module is provided. The three-way transmission and conversion circuit module includes a circuit board, having a signal conversion circuit thereon, where an upper surface and a lower surface of the circuit board both have a conductive sheet; and the aforementioned connector, where a part of the circuit board is inserted into the groove detachably to allow the elastic part to contact the conductive sheet.

According to an embodiment of the present invention, the thickness of the circuit board is corresponding to the height of the groove, to meet various assembling demands.

According to an embodiment of the present invention, the height of the groove is less than or equal to 1.6 mm.

According to an embodiment of the present invention, the connector includes locking parts, each having a hook structure extending along an inner edge of the groove, and an edge of the circuit board has a depressed structure to match the locking parts.

According to an embodiment of the present invention, the first connection part is connected to a control module, the second connection part is connected to an operation panel, and the connector is disposed on an expansion module, so as to realize signal transmission and conversion among the control module, the operation panel, and the expansion module.

It should be understood that, the aforementioned general description and the following detailed description of the present invention are both exemplary and illustrative, and are used to provide further interpretation for the present invention as claimed in the claims.

The embodiments of the present invention are described in detail with reference to the accompanying drawings. The preferred embodiments of the present invention are referred to in detail and the examples are shown in the accompanying drawings. In any possible case, same reference numerals are used to indicate same or similar parts in all the accompanying drawings. Furthermore, although terms used in the present invention are selected from well-known terms, some terms mentioned in the specification of the present invention are selected by the applicant according to judgment, and specific meaning of the terms are described in relevant parts herein. Furthermore, the present invention should be understood according to not only the used actual terms but also the meaning of each term.

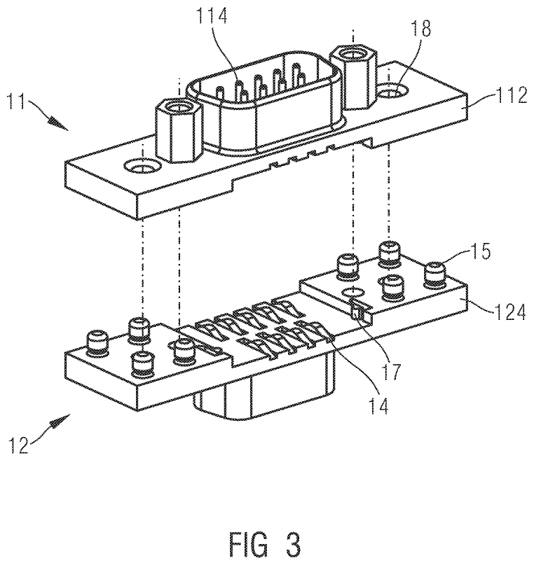

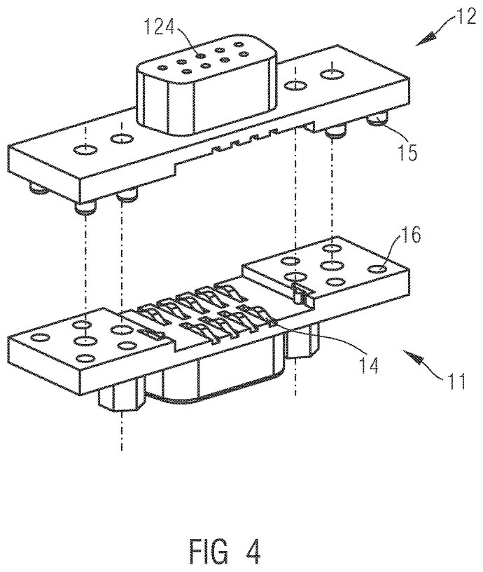

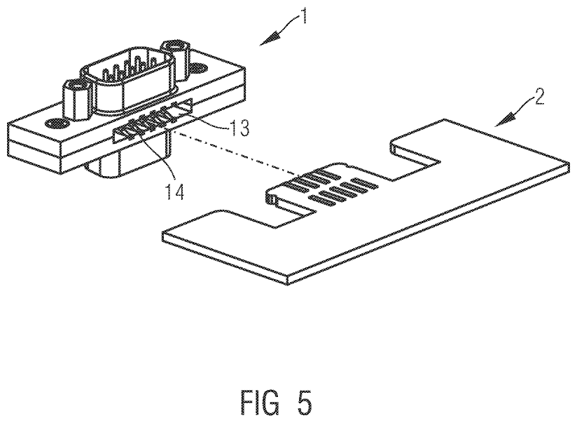

Referring to FIG. 3, FIG. 4, and FIG. 5, the basic principle and preferred embodiments of the present invention are discussed more specifically. A connector 1 according to the present invention includes a first connection part 11 and a second connection part 12, and the first connection part 11 and the second connection part 12 form a groove 13 suitable for accommodating a circuit board 2 when the first connection part 11 and the second connection part 12 are assembled together. That is, when the first connection part 11 and the second connection part 12 are docked, opposite surfaces of the first connection part 11 and the second connection part 12 form the groove 13, and elastic parts 14 are disposed on opposite inner surfaces of the groove 13, and the connector 1 and a circuit can be connected as long as one part of the circuit board 2 is inserted into the groove 13.

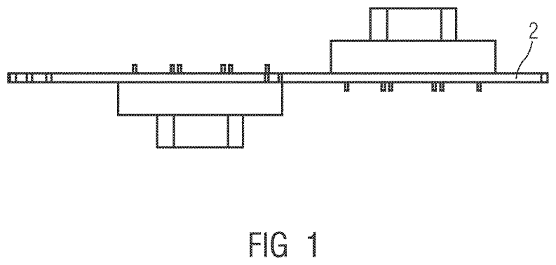

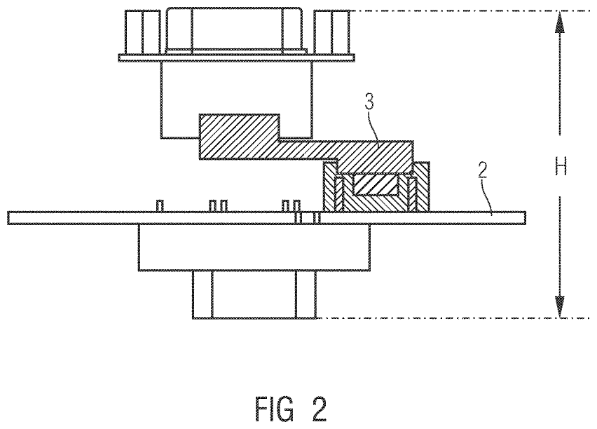

Referring to FIG. 1 and FIG. 2, two common connector structures in the prior art are described. To realize signal conversion and transmission between a front-end input and a rear-end output, at present, most of connectors on the market use an independent male head and an independent female head. For example, in the prior art shown in FIG. 1, the male head and the female head are directly welded on a circuit board, and this configuration occupies a large horizontal space of the circuit board. Alternatively, in the prior art shown in FIG. 2, the male head and the female head are connected through cables 3 for use, and this configuration occupies a large vertical space of the circuit board. The male head and the female head of the connector are applied to a product separately, causing the product to have a redundant volume and a small volume density, and need a complicated process. Compared with a solution of the prior art, the connector 1 of the present invention has a more compact structure and a lower height, thereby reducing space and enhancing competitiveness of a product significantly.

In an embodiment provided in the present invention, the elastic part 14 can be disposed on an inner surface of the first connection part 11 or the second connection part 12, or in an embodiment, the elastic part 14 can be disposed on the inner surfaces of both the first connection part 11 and the second connection part 12. The elastic part 14 can relatively displace relative to, for example, the inner surface of the first connection part 11 (or the second connection part 12). For example, when the groove 13 is idle, the elastic part 14 projects relative to the inner surface and is depressed inwards relative to a plane of the inner surface when the elastic part is pressed by an external force. Due to the elastic feature of the elastic part 14, the circuit board 2 can be inserted into the groove 13 conveniently. When the circuit board 2 is moved to a predetermined position, the elastic part 14 is in a pressed state to generate an outward resilient force, and the circuit board 2 can be fixed stably by using the resilient feature of the elastic part 14. Therefore, the circuit board 2 and the connector 1 can be assembled and connected stably via the elastic and resilient features of the elastic part 14. In a specific embodiment, the elastic part 14 may include multiple metal elastic sheets.

The connector 1 includes at least one input end and one output end. Therefore, at least one of the first connection part 11 and the second connection part 12 includes at least one terminal suitable to be plugged into an external port, so as to allow the connector 1 to be electrically connected to an external device through the at least one terminal. The elastic part 14 and the terminals are electrically connected, so that the circuit board 2 inserted into the groove 13 is connected to the external device through the elastic part 14. For example, the terminal can include a first terminal and a second terminal. Specifically, referring to FIG. 3 or FIG. 4, the first connection part 11 includes a first base 112 and a first terminal disposed on an external side of the first base 112, and the second connection part 12 includes a second base 122 and a second terminal disposed on an external side of the second base 122. To enhance the compatibility of the connector 1 and enable the connector 1 to be electrically connected to various external devices in a better manner, the terminal can be designed to have pins. In specific, the first terminal includes a first pin row 114, and correspondingly, the second terminal includes a second pin row 124, the pins can be aligned in two rows at an equal interval. For example, regarding the first connection part 11, the first pin row 114 is disposed on an external surface of the first connection part 11, multiple metal elastic sheets (that is, the elastic part 14) are distributed on the inner surface of the first connection part 11, the metal elastic sheets can be uniformly distributed at central positions of inner side surfaces of the first base 112 and the second base 122, and the quantity and positions of the metal elastic sheets are respectively corresponding to the quantity and positions of the pins in the first pin row 114 and the second pin row 124. In the embodiments shown in FIG. 3 and FIG. 4, the first pin row 114 has nine pins, and nine metal elastic sheets are disposed on positions corresponding to the nine pins, so that the metal elastic sheets and the pins are electrically connected in a one-to-one correspondence.

In a specific embodiment, the first base 112 and the second base 122 are both made of an insulating material through integrated injecting molding. For example, a plastic member can be used. A depressed part 10 is formed at the center of an inner end face of the first base 112 and/or the second base 122 relative to two ends, so as to form the groove 13 when the first base 112 and the second base 122 are docked.

Furthermore, the connector 1 can further include positioning columns 15 and positioning holes 16 matching the positioning columns. The positioning columns 15 are disposed on the first connection part 11, and the positioning holes 16 are formed in the second connection part 12, so that the first connection part 11 and the second connection part 12 can be fixedly connected through cooperation of the positioning columns 15 and the positioning holes 16. To fix the first connection part 11 and the second connection part 12 more firmly, threaded holes 18 can be formed in the first connection part 11 and the second connection part 12, extend along a direction of the height of the connector 1, and have inner threads formed therein. The threaded holes 18 are suitable for accommodating threaded connection pieces, so that the first connection part 11 and the second connection part 12 are fixed through the threaded connection pieces. In a preferred embodiment, the connector 1 can further include locking parts 17 that are disposed on inner side surfaces of the groove 13 oppositely. For example, in FIG. 3, each locking part 17 has a pair of fasteners extending along an inner edge of the groove 13, and the fasteners have a forked elastic hook structure that is suitable to fasten and position a part of the circuit board 2 inserted into the groove 13.

Preferably, the connector 1 is a D-Sub connector, the first connection part 11 has one connector structure of a male head and a female head, and the second connection part 12 has another connector structure of the male head and the female head. The D-Sub connector usually can be used in an analog or digital signal interface, is usually used to interface an external input or output in a product, and may have a male head or a female head. For a product requiring intermediate connection, the connector needs both a male head and a female head for connecting a front end and a rear end, so as to realize signal conversion and transmission between a front-end input and a rear-end output. The connector 1 may be, for example, any one of DB9, DB15, DB25, and DB37. According to a requirement of an interface of an external device, a D-Sub connector of a different model can be selected, so that the size of the port of the connector 1 and the quantity of the pins can satisfy a design requirement.

Furthermore, the present invention further provides a corresponding three-way transmission and conversion circuit module. The three-way transmission and conversion circuit module according to the present invention mainly includes a circuit board 2 and the aforementioned connector 1. The circuit board 2 has a signal conversion circuit, and an upper surface and a lower surface of the circuit board 2 both have a conductive sheet, a part of the circuit board 2 can be inserted into the groove 13 detachably, so as to allow the elastic part 14 to contact the conductive sheet. The circuit board 2 can be inserted into the connector 1 directly to realize conduction without an additional riveting action, thereby simplifying an entire structure and assembling process of the product. An edge of the circuit board 2 can have a depressed structure to match the locking parts 17. The thickness of the circuit board 2 is corresponding to the height of the groove 13. Specifically, the height of the depressed part 10 can be adjusted in order to change the size of the groove 13, in this way, circuit board 2 of various thickness can be assembled easily and the versatility of the connector 1 can be improved. In a specific embodiment, the height of the groove 13 is less than or equal to 1.6 mm. As shown in FIG. 5, multiple metal sheets are laid on the surface of the circuit board 2 as connection points, and the process is simple. During a design stage, signal transmission can be realized as long as a conversion circuit is designed in the circuit board. A signal transmission manner can be configured as required, and during use, three-way transmission and conversion of signals can be realized through configuration and conversion of the circuit board 2. A lower stack height and a more compact space layout can be provided by using the connector structure of the present invention.

In a specific application, the first connection part 11 is connected to a control module, the second connection part 12 is connected to an operation panel, and the connector 1 is disposed on an expansion module, so as to realize signal transmission and conversion among the control module, the operation panel, and the expansion module.

In view of the above, the connector 1 provided by the present invention can be tightly connected to the circuit board, so as to realize signal conversion and transmission. The circuit board 2 can be configured flexibly, and different conversion requirements can be configured as required, so as to realize signal conversion and a three-way form. A user can realize assembly more conveniently by inserting and removing the circuit board 2 directly, thereby reducing the complexity of the process, and the user can maintain and detach the connector more conveniently.

It is obvious that a person skilled in the art can perform various modifications and variations on the exemplary embodiments of the present invention without departing from the spirit and scope of the present invention, so that the present invention can cover modifications and variations of the present invention that fall within the scope of the appended claims and the equivalent technical solutions.

1. A connector, comprising:
a first connection part; and
a second connection part, the first connection part and the second connection part being configured to form a groove suitable to accommodate a circuit board when the first connection part and the second connection part are assembled together; and
elastic parts, disposed on opposite inner surfaces of the groove.

2. The connector of claim 1, wherein at least one of the first connection part and the second connection part includes at least one terminal, suitable to be plugged into an external port, the at least one terminal being electrically connected to at least one elastic part of the elastic parts, and
wherein the elastic parts include at least one metal elastic sheet, the at least one metal elastic sheet being electrically connected to the at least one terminal in a one-to-one correspondence.

3. The connector of claim 2, wherein
the at least one terminal further includes a first terminal and a second terminal,
the first connection part includes a first base, the first terminal being disposed on an external side of the first base,
the first terminal includes a first pin row,
the second connection part includes a second base, the second terminal being disposed on an external side of the second base,
the second terminal includes a second pin row, and
wherein a depressed part is formed at a center of an inner end face of at least one of the first base and the second base relative to two ends, so as to form the groove when the first base and the second base are docked.

4. The connector of claim 3, wherein the first base and the second base are both made of an insulating material through integrated injection molding.

5. The connector of claim 3, wherein the elastic parts include at least one metal elastic sheet, the at least one metal elastic sheet being uniformly distributed at central positions of inner side surfaces of the first base and the second base, and wherein quantity and positions of the at least one metal elastic sheet respectively correspond to quantity and positions of pins of the first pin row and the second pin row.

6. The connector of claim 1, further comprising:
positioning columns, disposed on the first connection part, wherein
positioning holes are formed in the second connection part, and wherein the first connection part and the second connection part are fixedly connected through cooperation of the positioning columns and the positioning holes.

7. The connector of claim 1, further comprising:
locking parts, disposed on inner side surfaces of the groove, oppositely, and each of the locking parts including a hook structure extending along an inner edge of the groove.

8. The connector of claim 1, further comprising:
threaded holes, formed in the first connection part and the second connection part, wherein the threaded holes are suitable for accommodating threaded connection pieces, so that the first connection part and the second connection part are fixed through the threaded connection pieces.

9. The connector of claim 1, wherein the connector is a D-Sub connector, the first connection part includes one connector structure of a male head or a female head, and the second connection part includes another connector structure of the male head or the female head.

10. The connector of claim 9, wherein the connector is one of DB9, DB15, DB25, and DB37.

11. A three-way transmission and conversion circuit module, comprising:
a circuit board, including a signal conversion circuit on the circuit board, an upper surface and a lower surface of the circuit board each including a conductive sheet; and
the connector of claim 1, wherein a part of the circuit board is detachably inserted into the groove to allow the elastic part to contact the conductive sheet.

12. The three-way transmission and conversion circuit module of claim 11, wherein the thickness of the circuit board is corresponding to the height of the groove.

13. The three-way transmission and conversion circuit module of claim 11, wherein a height of the groove is less than or equal to 1.6 mm.

14. The three-way transmission and conversion circuit module of claim 11, wherein the connector includes locking parts, each of the locking parts including a hook structure extending along an inner edge of the groove, and an edge of the circuit board including a depressed structure to match the locking parts.

15. The three-way transmission and conversion circuit module of claim 11, wherein the first connection part is connected to a control module, the second connection part is connected to an operation panel, and the connector is disposed on an expansion module, so as to realize signal transmission and conversion among the control module, the operation panel, and the expansion module.

16. The connector of claim 2, further comprising:
positioning columns, disposed on the first connection part, wherein positioning holes are formed in the second connection part and wherein the first connection part and the second connection part are fixedly connected through cooperation of the positioning columns and the positioning holes.

17. The connector of claim 2, further comprising:
locking parts, disposed on inner side surfaces of the groove, oppositely, and each of the locking parts including a hook structure extending along an inner edge of the groove.

18. The connector of claim 2, further comprising:
threaded holes, formed in the first connection part and the second connection part, wherein the threaded holes are suitable for accommodating threaded connection pieces, so that the first connection part and the second connection part are fixed through the threaded connection pieces.

19. A three-way transmission and conversion circuit module, comprising:
a circuit board, including a signal conversion circuit on the circuit board, an upper surface and a lower surface of the circuit board each including a conductive sheet; and
the connector of claim 2, wherein a part of the circuit board is detachably inserted into the groove to allow the elastic parts to contact the conductive sheet.

20. A three-way transmission and conversion circuit module, comprising:
a circuit board, including a signal conversion circuit on the circuit board, an upper surface and a lower surface of the circuit board each including a conductive sheet; and
the connector of claim 3, wherein a part of the circuit board is detachably inserted into the groove to allow the elastic parts to contact the conductive sheet.
